(19) United States
(12) Patent Application Publication
(10) Pub. No.: US 2009/0245168 A1
(43) Pub. Date: Oct. 1, 2009

(54) Server for Enhancing Communication Between a Content Provider and a Radio Communication Device and Method therefor

(76) Inventor: Gustav Soderstrom, Sodertalje (SE)

Correspondence Address: HARNESS, DICKEY & PIERCE, P.L.C., P.O. BOX 8910, RESTON, VA, 20195, US

(21) Appl. No.: 12/083,605

(22) PCT Filed: Nov. 3, 2006
(86) PCT No.: PCT/SE2006/001249

§ 371 Date: Jun. 24, 2008

(30) Foreign Application Priority Data
Nov. 4, 2005 (SE) 0502452-6
Dec. 6, 2005 (SE) 0502671-1

(51) Int. Cl. H04W 4/00

(52) U.S. Cl. 370/328

(57) ABSTRACT

The present invention relates to a server (103) for a general way of enhancing communication between a content provider (104, 105, 105) and a radio communication device (107) and a method therefor. A server (103) of the present invention automatically and dynamically collects data information from the radio communication device (107) of a user which accesses a content provider (104, 105, 106) and adds data information, from a content database (111), to data information provided by the content provider (202) in dependence on the data information collected from the radio communication device. In this way specific, automatically and dynamically tailored information can be added to the information received by a user who is accessing a service on the Internet.

### FIELD OF INVENTION

The present invention relates to a server for enhancing communication between a content provider and a radio communication device and a method therefor.

### BACKGROUND

In present day radio communication systems, new radio devices become more and more intelligent and are introduced side-by-side with older radio devices still serving a large community.

The communication capabilities of these radio communication devices are ever increasing and data packet communication is today commonplace, using for instance GPRS (General Packet Radio System). Data communication protocols used by radio communication devices, more specifically cellular radio communication devices, are, among others WAP 1.0 (Wireless Application Protocol), WAP 1.1, WAP 2.0, XHTML (Extensible HyperText Markup Language), HTTP (HyperText Transfer Protocol), HTTPS (HTTP Secure), TCP (Transport Control Protocol), IP (Internet Protocol) etc., where many cellular devices give access to only one or a few of these protocols.

Further, it is desirable for content providers to add user specific information, such as user specific ads, to the original content that the user is accessing on the Internet, such as when a user browsing Internet accesses a home page. This is somewhat difficult to achieve and is usually attained by making the user fill out forms, at registration, which forms sometimes are quite extensive.

It would thus be beneficial if a solution could be provided that would facilitate for service providers to more easily add user specific information to other content provided to a user.

### SUMMARY OF THE INVENTION

An object of the present invention is thus to provide a server and a method, respectively, which at least alleviate the above mentioned problems.

This object, among others, is attained by a server and a method, respectively, according to the appended claims.

An advantage with a server and a method, respectively, according to the appended claims is that a service provider can direct a service to a specific subset of radio communication devices, even individual radio communication devices. The service is based on data information relating to a specific radio communication device and is delivered together with data information requested by the radio communications device from a content provider.

Another advantage with a server and a method, respectively, according to the appended claims is that information automatically and dynamically adapted to capabilities of a radio communication device of a user can be added to the content that the user is accessing on the Internet, e.g. when browsing a site.

Further features and advantages of the present invention will be evident from the following description.

### BRIEF DESCRIPTION OF THE DRAWING

The present invention will become more fully understood from the detailed description of embodiments given below and the accompanying figure, which is given by way of illustration only, and thus, is not limitative of the present invention, wherein:

FIG. 1 is a schematic connection diagram of communication connections according to the present invention.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

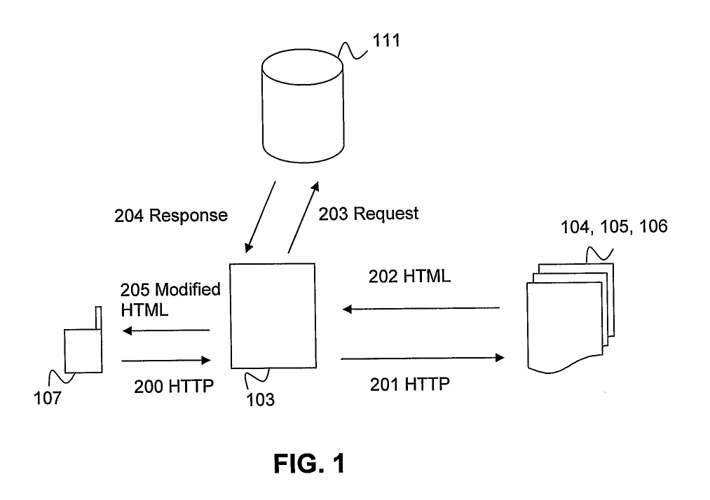

FIG. 1 is a schematic connection diagram for a mediating function server 103 according to a first embodiment of the present invention. FIG. 1 discloses communication between a radio communication device and a content provider. The content provider is one of plurality content providers in one or more first networks, such as Internet wherein communication is packet switched. The radio communication device is one of plurality radio communication devices in one or more second networks, such as different cellular/mobile/wireless networks. The operation of the server is as follows.

The radio communication device 107, sends 200 a HTTP (HypterText Transfer Protocol) request to the server 103. The server 103 automatically collects first data information about the radio communication device 107 from the header of the HTTP request comprising manufacturer information of the radio communication device, such as manufacturer, model, version, MSISDN (Mobile Station International Subscriber Directory Number), and capabilities of the radio communication device such as sound, video etc; and/or operator information, such as the operator of the second network in which the radio communication device operates. The operator can alternatively be identified by the originating IP address in a request. By automatically collecting first data information is meant collecting first data information without the user of the radio communication device having to perform any action.

The collected first data information is preferably stored in a user database for use e.g. when the user accesses Internet through a land based connection. If information about the user already exists in the user database any differing data is updated. In this way it is possible to collect first data information of a user's radio communication device even when he accesses e.g. Internet from a land-based connection.

The server 103 resends 201 the HTTP request to a content provider 104, 105 or 107. The content provider 104, 105 or 107 responds 202 with a HTML (HyperText Markup Language) home page. The server 103 collects second data information, the HTML home page.

The server 103 sends 203 a request, with at least a part of the first data information of the radio communication device, to a content database 111. This request can be sent when the response from the content provider is received, or alternatively parallel with the request to the content provider. The content database 111 returns 204 third data information in dependence on the first data information of the radio communication device back to the server 103. The server 103 adds the third data information returned from the content database 111 to the second data information of the HTML home page and returns 205 a response to the radio communication device 107 comprising third data information additional to that of the HTML home page.

The third data information dynamically collected from the content database may e.g. comprise one or more of the following: a software update, a link to a software update, an offer or information from the operator, an offer or information from the manufacturer, an offer or information from a third party, all of which are specific to the capabilities or context of this radio communication device. This allows a service provider to automatically direct a service to radio communication devices, which service dynamically is adapted to the radio communication device. By dynamically collected it is meant that the third data information is collected in dependence on newly collected first data information.

Further, the third data information can be in dependence also of the second data information. In this way the content provider, or a separate service provider, can easily add appropriate third data information to be transmitted to specific radio communication devices.

The radio communication device 107 can preferably be set to automatically accept data information making changes to the radio communication device, such as e.g. updating software, but may alternatively require user acceptance before any received data information is allowed to perform any changes to the radio communication device.

A second embodiment of the present invention will next be described, which is identical to the first embodiment described above apart from the following.

Instead of collecting the first data information from a HTTP request, an application, e.g. running in a JVM (Java Virtual Machine), in Windows, in Symbian, in Linux or in any other operating system, on the radio communication device procures the first data information relating to the radio communication device and provides the server with the possibility to collect the desired information of the manufacturer and/or the operator. This can e.g. be provided to the server via a TCP connection, as an alternative to an HTTP request when the application is accessing content on the Internet.

It will be obvious that the present invention may be varied in a plurality of ways. Such variations are not to be regarded as departure from the scope of the present invention. All such variations as would be obvious for a person skilled in the art are intended to be included within the scope of the present invention. For instance has a HTTP request been described as information carrier above, but other information carriers can also be used such as a TCP or an UDP connection.

1. A server for packet switched communication between a plurality of content providers in at least a first network and a plurality of radio communication devices in at least a second network, characterized in that
said server is provided to automatically collect first data information relating to a radio communication device of said plurality of radio communication devices,
said server is provided to collect second data information held by a content provider of said plurality of content providers connected to said radio communication device through said server,
said server is provided to dynamically collect third data information held by a content database, in dependence on said first data information, and
said server is provided to add said third data information to said second data information and to send said third data information added to said second data information to said radio communication device.

2. The server according to claim 1, wherein said first data information is collected from an HTTP request from said radio communication device.

3. The server according to claim 2, wherein said first data information is collected from a header of said HTTP request.

4. The server according to claim 2, wherein said first data information is collected from the originating IP address of said HTTP request.

5. The server according to claim 1, wherein said first data information is collected over a TCP connection of said radio communication device.

6. The server according to claim 1, wherein said first data information is collected from an application running on said radio communication device.

7. The server according to claim 5, wherein said first data information is collected from the originating IP address of said TCP connection.

8. The server according to claim 1, wherein said server is provided to collect said third data information further in dependence on said second data information.

9. The server according to claim 1, wherein said third data information is specific for said radio communication device.

10. The server according to claim 1, wherein said first data information comprises manufacturer information, such as one of the following parameters: device manufacturer, device model, phone software version, browser version, JVM version, MSISDN, and capabilities, such as sound, video etc of the radio communication device; and/or operator information, such as the operator.

11. The server according to claim 1, wherein said third data information comprises at least one of the following contents: a hyperlink to other content, a hyperlink to a program, and an ad.

12. A method for packet communication between a plurality of content providers located in at least a first network and a plurality of radio communication devices in at least a second network, characterized by the steps of:
automatically collecting first data information relating to a radio communication device of said plurality of radio communication devices,
collecting second data information held by a content provider of said plurality of content providers connected to said radio communication device,
dynamically collecting third data information held by a content database, in dependence on said first data information, and
adding said third data information to said second data information.

13. The method according to claim 12, comprising the step of sending said third data information added to said second data information to said radio communication device.

14. The method according to claim 12, wherein said step of collecting third data information further is in dependence on said second data information.
